(19) United States
(12) Patent Application Publication
(10) Pub. No.: US 2014/0334383 A1
(43) Pub. Date: Nov. 13, 2014

(54) NETWORK SYSTEM, NODE DEVICE, AND METHOD OF CONTROLLING NETWORK SYSTEM

(71) Applicant: FUJITSU LIMITED, Kawasaki-shi (JP)

(72) Inventors: Yumi Sakemi, Kawasaki (JP); Tetsuya Izu, London (GB); Kazuyoshi Furukawa, Kawasaki (JP); Hisashi Kojima, Yokosuka (JP); Masahiko Takenaka, Kawasaki (JP)

(73) Assignee: FUJITSU LIMITED, Kawasaki (JP)

(21) Appl. No.: 14/338,821

(22) Filed: Jul. 23, 2014

Related U.S. Application Data
(63) Continuation of application No. PCT/JP2012/001987, filed on Mar. 22, 2012.

(51) Int. Cl. H04W 12/10; H04W 84/18

(52) U.S. Cl. CPC H04W 12/10; H04W 84/18
USPC 370/328

(57) ABSTRACT

A node device which is provided in a network and for transmitting a packet including a first header portion, a second header portion, a payload data portion, the node device includes: a memory and a processor coupled to the memory. The processor is configured to: calculate a first value that is a first logical relationship for payload data set in the payload data portion and first header information including a transmission destination address set in the first header portion, and transmit a packet including the payload data, the first header information, second header information including a final transmission destination address set in the second header portion, the first value and a second value that is a second logical relationship to the payload data and the second header information to outside of the node device.

### CROSS-REFERENCE TO RELATED APPLICATION

This application is a continuation application of International Application PCT/JP2012/001987 filed on Mar. 22, 2012, the entire contents of which are incorporated herein by reference.

### FIELD

The technology disclosed herein relates to a technique for transmitting and receiving packets between nodes in a network system.

### BACKGROUND

As a network system, for example, an ad hoc network is known. The ad hoc network is a type of self-configuring network linked via wireless or wire communication. The ad hoc network is formed by a plurality of devices having a communication function. The devices having a communication function in the ad hoc network are called nodes. Also, each node in the ad hoc network transmits and receives packets via multihop communication. Multihop communication is a technique that enables, even between nodes that are not present in the communication area of one another, communication via another node present in the communication area of each node.

For example, as a system using the ad hoc network, a meter reading system in which a node that is communicable via wireless communication is built in a wattmeter of each household to thereby collect power consumption of each household via the ad hoc network system has been known. In the meter reading system, the packet containing the power consumption of each household detected by each wattmeter is transferred to a system of an electric utility company from each node built in the wattmeter of each household. Thus, the packet transferred by the meter reading system contains personal information about usage of electric power of each household.

In view of confidentiality and tamper proof, in communication using an ad hoc network, secure communication is preferably performed. As an example of secure communication, a method in which the entire or a part of the packet is encrypted and is thus transferred is used. As another example, a method in which a message authentication code (a MAC value) that is a type of code information for a packet is stored in the packet and the packet is thus transferred has been known.

As a related art, a technique in which the MAC value calculated by a node that has received the packet is checked with the MAC value contained in the packet and thus the node verifies the packet has been known.

A method for verifying a packet used in the related art will be described below. The packet includes a communication header, a data portion, and a MAC value storage portion. The communication header contains various types of information, such as a source address, a destination address, a transfer source address, a transfer destination address, and the like. First, a node X that transfers a packet calculates a MAC value A for the communication header and the data portion in accordance with a predetermined algorithm. In the predetermined algorithm, a method for calculating code information is defined. The node X stores the obtained MAX value A in the MAC value storage portion. Then, the node X transmits the packet to a node Y that is the transfer destination.

The node Y that has received the packet transmitted from the node X calculates a MAC value B for the communication header and the data portion contained in the packet in accordance with a predetermined algorithm. Next, the node Y compares the MAC value A stored in the MAC value storage portion in the packet and the obtained MAC value B with one another. Then, as a result of the comparison, if the MAC value A and the MAC value B match one another, the node Y transfers the packet to a node Z that is a new transfer destination.

On the other hand, if the MAC value A and the MAC value B do not match one another, the node Y discards the received packet. By the above-described method, a node that has received a packet verifies the packet using the MAC value.

As a related art, for example, International Publication Pamphlet No. WO2011/121713 is known.

### SUMMARY

According to an aspect of the invention, an ad hoc network system which includes a plurality of node devices and in which a packet including a first header portion, a second header potion, and a payload data portion is transferred, the ad hoc network system includes: a first node device that is one of the plurality of nodes device and includes a first processor; and a second node device that is one of the plurality of node devices and includes a second processor. The first processor is configured to: calculate a first value that is a first logical relationship for payload data set in the payload data portion and first header information including a transmission destination address set in the first header portion, and transmit a packet including the payload data, the first header information, second header information including a final transmission destination address set in the second header portion, the first value, and a second value that is a second logical relationship to the payload data and the second header information to outside of the first node device. The second processor is configured to perform, when a value that is to be the first logical relationship to information stored in the payload data portion in the packet received from outside of the second node device and information stored in the first header portion does not match the first value and a value that is the second logical relationship to information stored in the payload data portion in the received packet and information stored in the second header portion matches the second value, control that causes transmission of a packet based on the received packet to a third node device that is one of the plurality of node devices.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a network system according to an embodiment;

FIG. 2 is a diagram illustrating an example data configuration of a packet;

FIG. 3 is a diagram illustrating a first value and a second value;

FIG. 4 is a functional block diagram of a node in the example;

FIG. 5 is a table illustrating an example data configuration of a routing table stored by a routing table storage section;

FIGS. 6A, 6B, 6C, 6D and 6E are tables illustrating example data tables of various types provided in a key information storage section;

FIG. 7 is a flow chart of packet generation processing in the example;

FIG. 8 is a flow chart of packet verification processing in the example;

FIG. 9 is a sequence diagram illustrating a flow of transmission of a packet within an ad hoc network;

FIG. 10 is a flow chart of packet generation processing in another example;

FIG. 11 is a flow chart of packet verification processing in the another example; and

FIG. 12 is a diagram illustrating an example hardware configuration of a node.

### DESCRIPTION OF EMBODIMENT

As in the above-described case where the MAC value is used, each node in a network system verifies the packet for data contained in a packet using a value having a predetermined logical relationship, and thus, can discard a packet for which completeness is not verified. However, there might be cases where, in the course of transferring the packet, a part of data contained in the packet is lost or is rewritten for some reason. An object of the network system is to transmit a packet containing payload data to a target address via multihop communication but, in the related art, there is a probability that a packet that is to be transferred is discarded. Note that the payload data is data other than additional information, such as a header, a trailer, and the like, among data forming the packet.

According to this embodiment, in verification of the completeness of data in a packet using a value having a predetermined logical relationship with the data contained in the packet, for a packet that is to be transferred, only when a part of the completeness is verified, priority is put in transfer of the packet.

According to this embodiment, a packet may be effectively transferred to a target transmission destination.

An embodiment for a communication apparatus, a communication method, and a system according to the present disclosure will be described below with reference to the accompanying drawings.

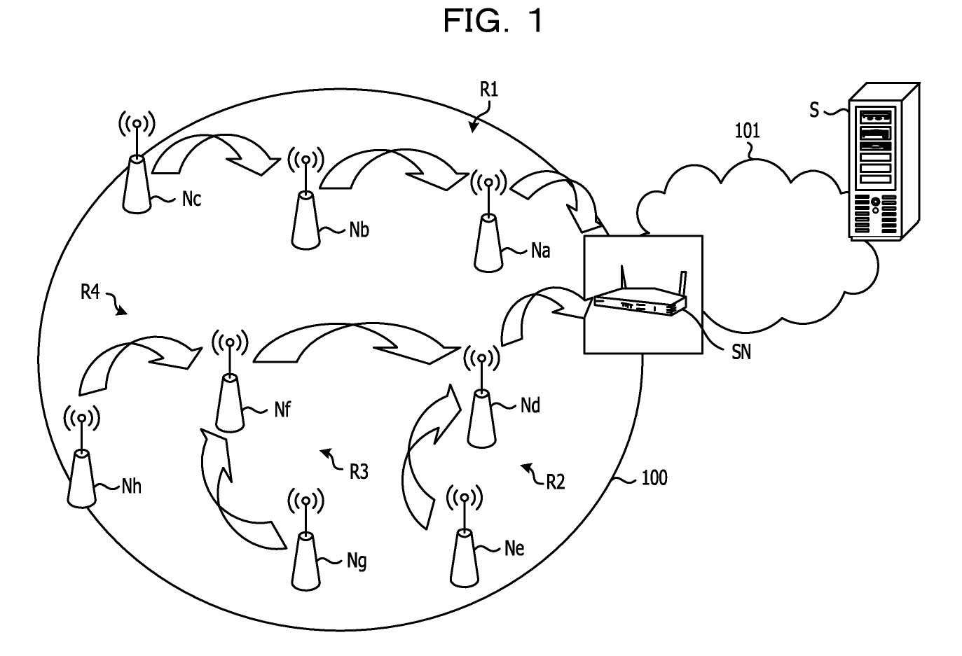

FIG. 1 is a diagram illustrating an example of a network system according to the embodiment. The network system includes a plurality of nodes N, a sink node SN, and a server S. First, a network system according to this embodiment and packet transmission in the network system will be described with reference to FIG. 1. The network system according to this embodiment is an ad hoc network system.

The server S and the sink node SN are coupled to one another via a normal network 101, such as the Internet, a LAN, a WAN, and the like. The sink node SN and the nodes Na-Nh are coupled to one another via an ad hoc network 100.

In the ad hoc network 100, a plurality of nodes N is provided. In FIG. 1, the nodes Na-Nh are illustrated as representatives of the plurality of nodes N.

The sink node SN is a relay device that couples the ad hoc network 100 and the normal network 101 with one another. The sink node SN is capable of transmitting and receiving both of information in the format of a protocol of the ad hoc network 100 and information in the format of a protocol of the normal network 101.

The sink node SN performs communication by performing protocol conversion of information between the ad hoc network 100 and the normal network 101. For example, a packet transmitted from one of the nodes N provided in the ad hoc network 100 to the server S is protocol-converted by the sink node SN. Thereafter, the sink node SN transmits the packet to the normal network 101, and thereby, the packet reaches the server S.

Data transmitted from the server S and the sink node SN to each node N is protocol-converted in the sink node SN and is transmitted as a packet from the sink node SN to each node N provided in the ad hoc network 100.

The sink node SN comprehends whether or not communication between the nodes N is possible with reference to a routing table. The sink node SN autonomously generates a transmission route of a packet based on the information of the routing table.

Note that each node N may individually generate a routing table. Each node N exchanges information about a communication situation with corresponding nodes N therearound. Then, each node N generates a routing table based on information about the communication situation. For example, even when the node Nf and the node Ng are not communicable, a new transmission route can be set. For example, the node Ng can build a new route via the node Ne. In this embodiment, assuming that each node generates a routing table, the following description will be provided.

Each node is a device that is capable of multihop communication with another node that is communicable in a predetermined communication area. In the ad hoc network 100, not all of the nodes Na-Nh have to be capable of directly communicating with the sink node SN and each of the nodes Na-Nh communicates with the sink node SN through communication via another node.

Thus, in the ad hoc network 100, some of the nodes may be communicable with the sink node SN. In FIG. 1, each of the nodes Na and Nd is a node that is directly communicable with the sink node SN.

Note that, in the example of FIG. 1, a single sink node SN is provided in the ad hoc network 100 but a plurality of sink nodes SN may be provided in a single ad hoc network 100. Also, in the example of FIG. 1, a single ad hoc network 100 is provided but a plurality of ad hoc networks may be provided. When a plurality of ad hoc networks is provided, each of the plurality of ad hoc networks includes at least one sink node SN. The server S is connected to each sink node SN via the normal network. This configuration enables transmission and reception of data between the server S and each of all of the nodes N.

The ad hoc network system according to this example is applied to, for example, a system that collects the power consumption of each household. In such a system, each node N is installed in the wattmeter of each household used for detecting the power consumption of each household. Each node N transmits the detected power consumption to the server S via the sink node SN. Thus, the server S collects the power consumption of each household.

For example, assume that the node N is built in the wattmeter of each household. Each node N transmits the power consumption of each household via the ad hoc network 100.

Note that the power consumption of each household may be measured by each node and may be obtained by each node from the wattmeter. Each node stores the detected power consumption in its own storage area. The sink node SN transmits the power consumption of each household received from each node provided in the ad hoc network 100 to the server S of the electric utility company via the normal network 101. Thus, the power consumption is collected without a worker going to each household to collect it.

In addition, use of this network system is not limited to collection of the power consumption but the network system may be configured such that each node has a sensor function of detecting temperature, humidity, the light amount, and the like, and thus may be used in research of, for example, the environment and the like.

In FIG. 1, four routes R1-R4 are set by the nodes Na-Nh forming the ad hoc network 100. For example, the route R1 is a route including the node Nc, the node Nb, the node Na, and the sink node SN. The route R2 is a route including the node Ne, the node Nd, and the sink node SN. The route R3 is a route including the node Ng, the node Nf, the node Nd, and the sink node SN. The route R4 is a route including the node Nh, the node Nf, the node Nd, and the sink node SN. Note that each of the node Na and the node Nd is a node that directly communicates with the sink node.

Nodes near the sink node SN will be hereinafter called upstream nodes. Note that, depending on the size of the ad hoc network 100, the node Nb and the node Ne serve as upstream nodes. When data is transmitted from each of the nodes Na-Nh to the server S, each of the nodes Na-Nh transmits data detected by each node to the sink node SN such that the data follows the corresponding one of the routes R1-R4.

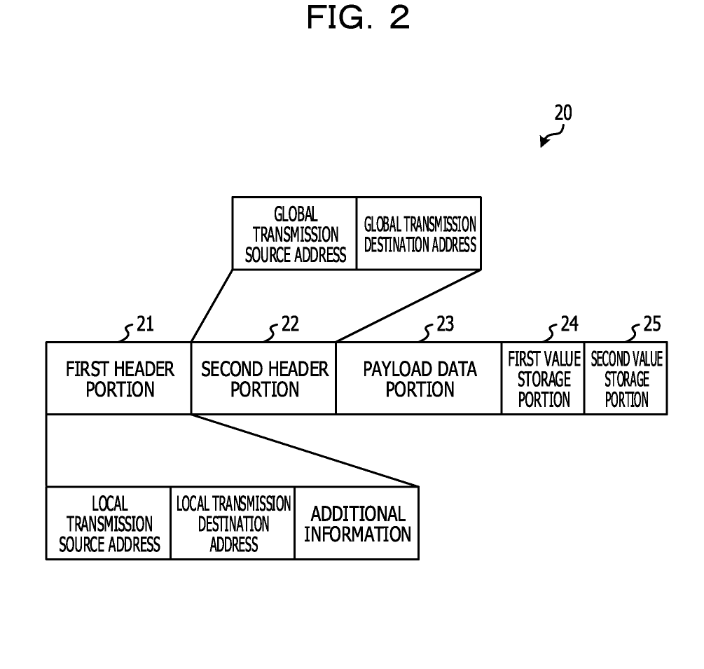

Now, an example data configuration of a packet will be described. FIG. 2 is a diagram illustrating an example data configuration of a packet.

A packet 20 includes a first header portion 21, a second header portion 22, a payload data portion 23, a first value storage portion 24, and a second value storage portion 25. First header information is written in the first header portion 21. The first header information contains a local transmission source address, a local transmission destination address, and additional information.

The local transmission source address is information about the address of a device that transmits the packet 20. The local transmission destination address is information about the address of a device that is a destination of the packet 20. Note that, in this example, the local transmission source address and the local transmission destination address are the addresses of a node and a sink node.

The additional information is header information other than the local transmission source address, the local transmission destination address, a global transmission source address, and a global transmission destination address. For example, the additional information is information, such as the date and time of transmission, the number of transfers, and the like. Note that the global transmission source address and the global transmission destination address will be described in detail later.

Second header information is written in the second header portion 22. The second header information contains the global transmission source address and the global transmission destination address. The global transmission source address is information about the address of a device that has generated payload data written in the payload data portion 23. The global transmission destination address is information about the address of a device that finally receives the payload data written in the payload data portion 23. Note that, in this example, the global transmission source address and the global transmission destination address are the addresses of a node, a sink node, and a server.

Payload data is written in the payload data portion 23. For example, in a meter reading system, the payload data contains information of the power consumption of each household and the like. A first value for use in verifying the completeness of the packet 20 is written in the first value storage portion 24. A second value for use in verifying the completeness of the packet 20 is written in the second value storage portion 25. Note that “verifying completeness” herein is verifying whether or not data contents of a packet when it is generated and data contents of a packet when it is received match one another.

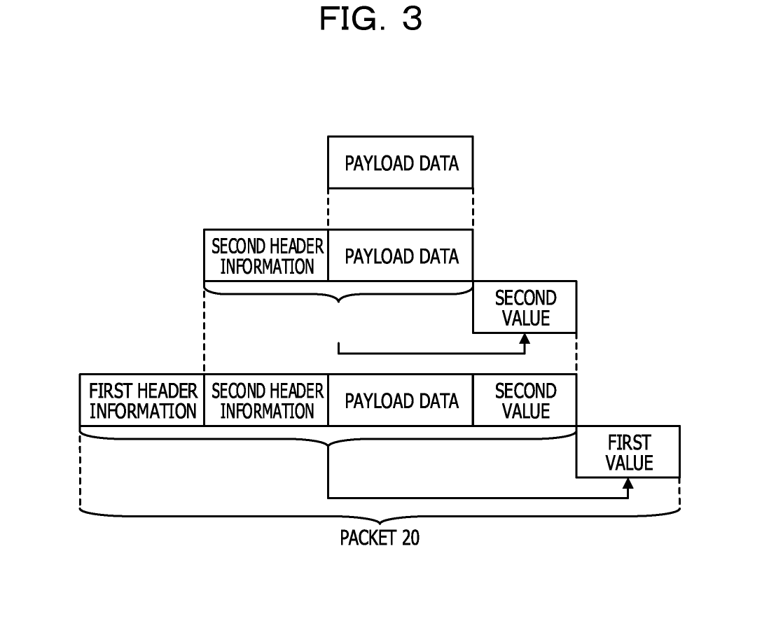

FIG. 3 is a diagram illustrating the first value and the second value. A case where the first value and the second value are set for a packet containing data obtained by the node N will be hereinafter described.

First, the node N sets payload data containing obtained data in the payload data portion 23. In this case, the node N ensures confidentiality of the payload data by encrypting the payload data using an encryption key. The encryption key is a key shared by each node and the server. Also, as the encryption key, a different key may be provided for each node and a common key may be provided for all of the nodes.

Furthermore, the node N generates the second header information. The second header information contains the global transmission source address and the global transmission destination address. The node N stores the second header information in the second header portion 22. The node N calculates the second value for use in verifying the completeness of the second header information and the encrypted payload data based on an algorithm that has been defined in advance. The node N sets the second value in the second value storage portion 25. Data containing the second header information and the encrypted payload data will be hereinafter referred to as application data.

The second value is a value in a predetermined logical relationship to the application data. For example, the second value is a value, such as a hash value, a MAC value, a MDC value, and the like, obtained by compressing the application data into a character string, which has a certain length. In this example, as described below, a MAC value calculated using an application data MAC key is used as the second value.

In this example, the node N calculates the MAC value of the application data using the application data MAC key. As the application data MAC key, a key that has been shared in advance by each node, the sink node, and the server is used.

The node N generates the first header information. The first header information contains the local transmission source address and the local transmission destination address. The node N stores the first header information in the first header portion. The node N calculates the first value for use in verifying the completeness of the first header information and the application data based on an algorithm that has been defined in advance. The node N sets the first value in the first value storage portion 24. Data containing the first header information, the application data, and the second value will be referred to as ad hoc data.

The first value is a value in a predetermined logical relationship to the ad hoc data. For example, the first value is a value, such as a hash value, a MAC value, a MDC value, and the like, obtained by compressing the ad hoc data to a character string having a certain length. In this example, as described below, a MAC value calculated using an ad hoc data MAC key is used as the first value.

In this example, the node N calculates the MAC value of the ad hoc data using the ad hoc data MAC key. The ad hoc data MAC key is shared by at least two nodes. The two nodes are a node corresponding to the local transmission source address and a node corresponding to the local transmission destination address. The ad hoc data MAC key may be a key that is the same as the application data MAC key and is shared by all of the nodes.

As described above, the first header information, the second header information, the payload data, the first value, and the second value are set for respective locations allocated in the packet 20 in advance, and are transmitted from the node N to another node.

An example illustrated in FIG. 1 where data of power consumption obtained by the node Nc is transmitted to the server S via the ad hoc network will be described. The node Nc sets the payload data containing the obtained data of the power consumption to the payload data portion 23. In this case, the node Nc encrypts the payload data using an encryption key.

Furthermore, the node Nc sets, as the global transmission source address, the address of the node Nc in which the data of the power consumption is obtained in the second header portion 22. Also, the node Nc sets, as the global transmission destination address, the address of the sink node SN in the second header portion 22.

The node Nc calculates a MAC value for the application data using the application data MAC key and sets the MAC value in the second value storage portion 25. Subsequently, the node Nc sets, as the local transmission source address, the address of the node Nc in the first header portion 21. The node Nc sets, as the local transmission destination address, the address of the node Nb in the first header portion 21. Information, such as the date and time of transmission, and the like, may be further written in the first header portion 21.

In addition, the node Nc identifies a node that is a transmission destination with reference to a routing table for the route R1 generated in advance. The routing table will be described in detail later.

Next, the node Nc calculates the MAC value for the ad hoc data using the ad hoc data MAC key and sets the MAC value in the first value storage portion 24. For example, a key shared by the node Nc and the node Nd in advance is employed as the ad hoc data MAC key. The node Nc transmits the packet 20 generated in the above-described manner to the node Nb.

The node Nb that has received the packet from the node Nc verifies the received packet. The node Nb calculates a MAC value for the ad hoc data in the received packet using the ad hoc data MAC key held by the Nb. The node Nb compares the MAC value stored in the first value storage portion 24 in the packet and the calculated MAC value with one another.

If the two MAC values match one another, the completeness of the ad hoc data in the packet received by the node Nb is affirmed. When the two MAC values for the ad hoc data match one another, the node Nb allows further transmission of the received packet. The node Nb rewrites the first header information and sets a new first value in accordance with the route R1, and transmits the packet to the node Na.

On the other hand, if the MAC value stored in the first value storage portion 24 in the packet and the calculated MAC value do not match one another, the node Nb denies the completeness of the ad hoc data in the received packet. In this case, according to the related art, the node Nb discards the received packet. That is, the payload data contained in the packet that has reached to the node Nb does not reach the server S.

However, according to this example, the node Nb further verifies the completeness of the application data. The node Nb calculates the MAC value for the application data using the application data MAC key. Then, the node Nb compares the MAC value stored in the second value storage portion 25 in the received packet and the calculated MAC value with one another.

If the two MAC values match one another, the completeness of the application data in the packet received by the node Nb is affirmed. When the two MAC values for the application data match one another, the node Nb allows further transfer for the application data in the received packet. The node Nb gives new first header information to the application data in the received packet, and then, transfers the packet to the node Na in accordance with the route R1.

If the MAC value stored in the second value storage portion 25 in the received packet and the calculated MAC value do not match one another, the node Nb denies the completeness of the application data in the received packet. Since the completeness of the payload data and the second head information has not been proved, the node Nb discards the received packet.

As described above, a node that transmits a packet sets the second value for use in verifying the completeness of the application data and the first value for use in verifying the completeness of the ad hoc data in the packet. Furthermore, a node that transmits a packet encrypts payload data, and therefore, the confidentiality of the payload data is ensured.

On the other hand, if the completeness of the application data is confirmed based on the first value and second value, a node that has received a packet allows transfer of the packet. Furthermore, even in the case where the completeness of the application data is not confirmed, if the completeness of the ad hoc data is confirmed, the node can transfer the packet.

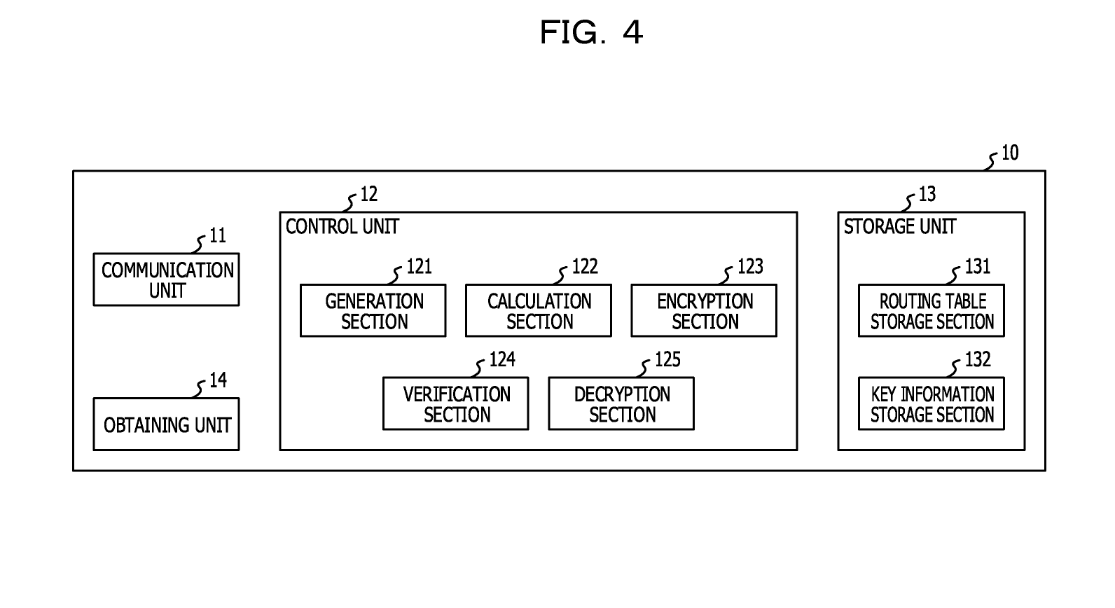

FIG. 4 is a functional block diagram of a node in this example. Note that the node illustrated in FIG. 4 has a function of generating a packet for transmission and a function of verifying the completeness of a received packet.

A node 10 includes a communication unit 11, a control unit 12, a storage unit 13, and an obtaining unit 14. The communication unit 11 is a processing unit that performs wireless communication with another node or the sink node SN. For example, the communication unit 11 receives a packet from another node. Also, the communication unit 11 transmits a packet to another node.

The control unit 12 is a processing unit that controls various types of processing of the node 10. For example, when the node 10 transmits a packet, the control unit 12 generates a packet for transmission. Also, when the node 10 receives a packet, the control unit 12 verifies the completeness of the packet.

The storage unit 13 stores various types of information. For example, the storage unit 13 stores an encryption key used for encryption processing, a key used for calculation processing of the first value and the second value, the routing table, and the like.

The obtaining unit 14 is a processing unit that obtains transmission data. For example, the obtaining unit 14 obtains data, such as power consumption, temperature, and the like, from the node 10 and a communicable sensor. Note that the obtained data is transmitted as a part of payload data to another node or the sink node.

The control unit 12 includes a generation section 121, a calculation section 122, an encryption section 123, a verification section 124, and a decryption section 125. The generation section 121 is a processing unit that generates a packet for transmission. For example, the generation section 121 identifies a transmission destination node with reference to the routing table stored in the storage unit 13. Furthermore, the generation section 121 sets the address of the identified node for the local transmission destination address.

The calculation section 122 is a processing unit that calculates at least the first value. The calculation section 122 may calculate the second value. The calculation section 122 calculates the first value having a predetermined logical relationship to ad hoc data. In this example, for example, the calculation section 122 calculates a MAC value for the ad hoc data using an ad hoc data MAC key.

When a packet containing, as a part of payload data, data obtained by the obtaining unit 14 is generated, the calculation section 122 calculates the second value having a predetermined logical relationship to application data. In this example, for example, the calculation section 122 calculates a MAC value for the application data using an application data MAC key.

Note that the predetermined logical relationship of the first value and the predetermined logical relationship of the second value may be the same or different. Accordingly, the ad hoc data MAC key and the application data MAC key may be the same or different. In this example, it is assumed that the ad hoc data MAC key and the application data MAC key are different.

The encryption section 123 executes encryption processing of payload data, as appropriate. For example, the encryption section 123 encrypts application data containing payload data using an encryption key.

The verification section 124 is a processing unit that verifies, when the communication unit 11 receives a packet from another node, the completeness of the packet and controls transfer of the packet in accordance with the result of the verification. For example, the verification section 124 verifies the completeness of ad hoc data in the packet using the first value stored in the first value storage portion 24 in the packet. That is, the verification section 124 verifies whether or not a value corresponding to a first logical relationship to the ad hoc data in the received packet matches the first value stored in the received packet. When the value matches the first value, the completeness of the ad hoc data in the received packet is proved. When the completeness of the ad hoc data is proved, the verification section 124 allows transfer of the packet.

In this example, the verification section 124 calculates a MAC value for ad hoc data as a target using the ad hoc data MAC key. The verification section 124 compares the calculated MAC value and the MAC value stored in the first value storage portion 24 with one another, thereby verifying the completeness of the ad hoc data.

If the completeness of the ad hoc data is denied, the verification section 124 verifies the completeness of application data using the second value stored in the second value storage portion 25 in the packet. That is, the verification section 124 verifies whether or not a value corresponding to a second logical relationship to the application data in the received packet matches the second value stored in the received packet. If the value matches the second value, the completeness of the application data in the received packet is proved. When the completeness of the application data is proved, the verification section 124 allows transfer of the packet.

Note that the verification section 124 may be configured to select, when the completeness of ad hoc data is denied, one of a transfer priority mode in which the completeness of application data is further verified and a security priority mode in which only the completeness of ad hoc data is verified.

For example, the verification section 124 determines the mode that is set and performs, when the transfer priority mode is set, verification using the first value and the second value. Even in the case where the completeness of ad hoc data is denied, if the completeness of application data is affirmed, the verification section 124 allows transmission of the application data, and thus, the node 10 is enabled to put priority on transmission of a packet.

On the other hand, when the security priority mode is set, the verification section 124 discards, if the completeness of the ad hoc data is denied, the packet. Thus, unless the completeness of the ad hoc data is proved, transmission of the received packet is not allowed, and thus, security is increased.

The node 10 of this example is configured such that one of the modes may be selected, and thus, can switch, as appropriate, its operation between an operation in which priority is put on transmission and an operation in which priority is put on security, as appropriate.

The decryption section 125 decrypts encrypted payload data, as appropriate. For example, the decryption section 125 determines whether or not the global transmission destination address is the address of its own node with reference to the second header portion 22 in the packet. When the global transmission destination address is its own address, the decryption section 125 decrypts application data using a decryption key.

As described above, when the obtaining unit 14 obtains data transmitted as payload data, the control unit 12 functions as the generation section 121, the calculation section 122, and the encryption section 123. On the other hand, when payload data contained in a packet received from another node is transferred, the control unit 12 functions as the generation section 121, the calculation section 122, and the verification section 124.

When a packet received from another node is directed to the node that has received the packet itself, the control unit 12 functions as the verification section 124 and the decryption section 125.

Next, the storage unit 13 will be described. The storage unit 13 includes a routing table storage section 131 and a key information storage section 132.

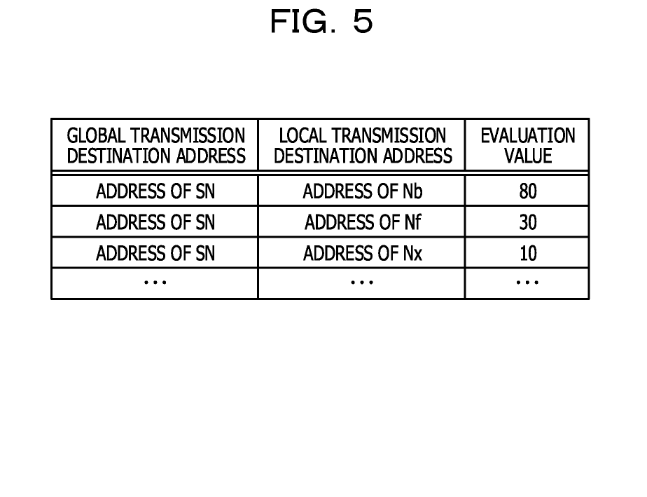

FIG. 5 is a table illustrating an example data configuration of a routing table stored by the routing table storage section 131. The routing table is stored in association with the global transmission destination address, the local transmission destination address, and an evaluation value. FIG. 5 illustrates a routing table of the node Nc.

The global transmission destination address is information of the address of a device that finally receives a packet. As the global transmission destination address, information of the address of another node N or information of the address of the sink node SN is stored.

The local transmission destination address is information of the address of a device that directly receives a transmitted packet. As the local transmission destination address, information of the address of another node N or information of the address of the sink node SN is stored.

The evaluation value is a value indicating which local transmission destination address is preferable as the nearest transmission destination of a packet in a combination of the global transmission destination address and the local transmission destination address. The evaluation value is calculated based on communication intensity with surrounding nodes and the like. The evaluation value is obtained by the same method as the method used in routing that has been widely performed according to a known technique.

In the example illustrated in FIG. 5, when the global transmission destination address is “the address of the sink node SN”, “the address of the node Nb” the evaluation value of which is the highest is identified as the local transmission destination address. The example of FIG. 1 indicates that the local transmission destination address the evaluation value of which is the highest in the routing table of each node is adopted and, as a result, the route R1 is determined.

For example, in order to transmit data obtained by the obtaining unit 14 in the node Nc to the server via the sink node SN, first, the generation section 121 sets, as the global transmission destination address, “the address of the sink node SN” in the second header portion 22. Furthermore, the generation section 121 identifies “the address of the node Nb” the evaluation value of which is the highest among a plurality of local transmission destination addresses corresponding to “the address of the sink node SN” with reference to the routing table. Then, the generation section 121 sets, as the local transmission destination address, “the address of the node Nb” that has been identified in the first header portion 21.

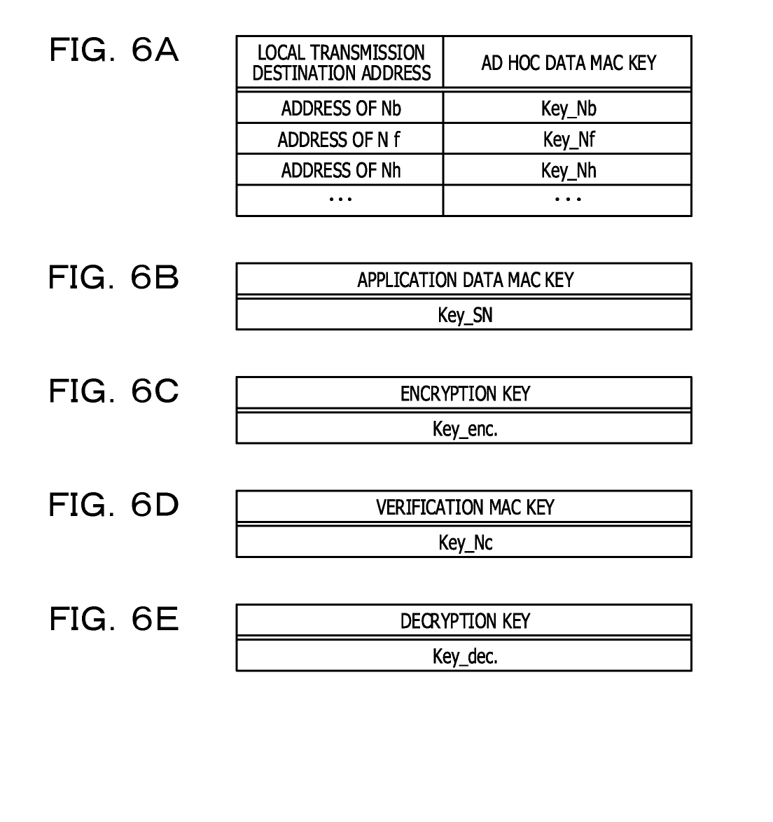

FIGS. 6A, 6B, 6C, 6D and 6E are tables illustrating examples data tables of various types included in the key information storage section 132. The key information storage section 132 stores an ad hoc data MAC key management table, an application data MAC key management table, an encryption key management table, a verification MAC key management table, and a decryption key management table.

FIG. 6A illustrates an example data configuration of the ad hoc data MAC key management table. The ad hoc data MAC key management table stores the local transmission destination address and information of the ad hoc data MAC key in association with one another. The local transmission destination address is a local transmission destination address set in the first header portion 21 in a packet. Note that, instead of the local transmission destination address, an ID that uniquely identifies a node, and the like, may be used. The ad hoc data MAC key is a MAC key used in transmitting a packet to the local transmission destination address. For example, when the generation section 121 identifies the address of the node Nb as the local transmission destination address, the calculation section 122 obtains the ad hoc data MAC key “Key_Nb” corresponding to the local transmission destination address “ADDRESS OF NODE Nb” from the ad hoc data MAC key management table. Then, the calculation section 122 calculates a MAC value that is to be the first value using the selected ad hoc data MAC key.

FIG. 6B illustrates an example data configuration of the application data MAC key management table. The application data MAC key management table stores information of an application data MAC key. The calculation section 122 calculates a MAC value for application data using the application data MAC key. Note that the application data MAC key management table may store a plurality of application data MAC keys in accordance with the global transmission destination address.

FIG. 6C illustrates an example data configuration of the encryption key management table. The encryption key management table stores information of an encryption key. Note that the encryption key management table may store a plurality of encryption keys in accordance with the global transmission destination addresses.

FIG. 6D illustrates an example data configuration of the verification MAC key management table. The verification MAC key management table stores information of a verification MAC key. The verification MAC key is a MAC key used for verifying, when a packet is received, the completeness of ad hoc data in the received packet.

Note that, in this example, in order to verify the completeness of application data, the application data MAC key is used. On the other hand, in order to verify the completeness of ad hoc data, the ad hoc data MAC key adopted in the node that has transmitted the packet is used.

As described above, in this example, the node that transmits a packet uses the ad hoc data MAC key in accordance with the local transmission destination of the packet to calculate the MAC value, which is the first value. Accordingly, the verification MAC key management table stores the ad hoc data MAC key shared by its own node with another node.

The node Nb shares the verification MAC key of the node Nb with a surrounding node, such as the node Nc and the like, in advance. The node Nb stores, as the verification MAC key, the MAC key shared with another node in the verification MAC key management table of the key information storage section 132 of its own.

On the other hand, the node Nc stores the ad hoc data MAC key of the node Nb in association with the address of the node Nb.

Note that FIG. 6D illustrates the verification MAC key management table in the node Nc and “Key_Nc”, which is the ad hoc data MAC key shared by the node Nc with another node is stored as the verification MAC key.

FIG. 6E illustrates an example data configuration of the decryption key management table. The decryption key management table stores information used for decrypting the encrypted payload data. Note that the decryption key management table may store a plurality of decryption keys in accordance with the global transmission destination address. Also, a configuration in which the key information storage section 132 does not have the decryption key management table and decryption is performed using an encryption key stored in the encryption key management table may be employed.

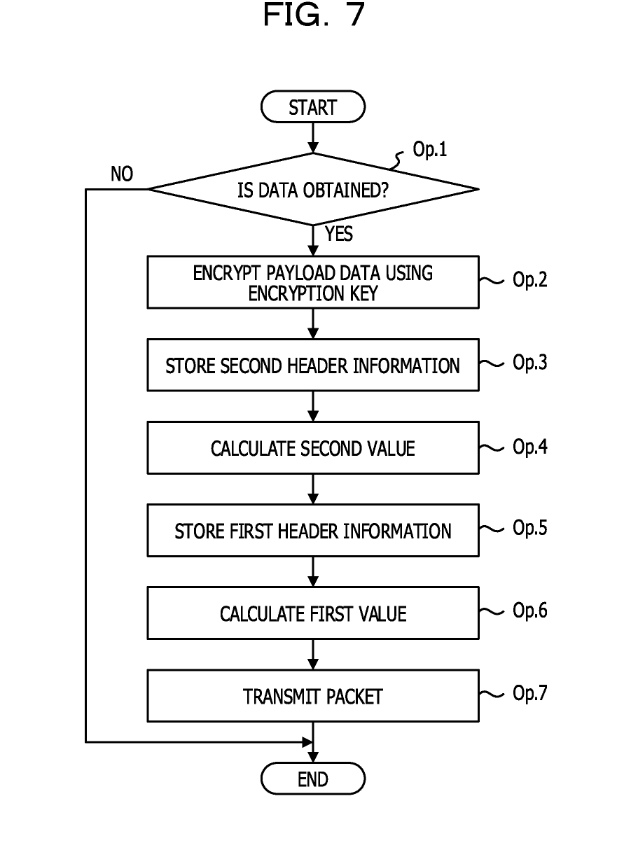

FIG. 7 is a flow chart of packet generation processing. First, whether or not the obtaining unit 14 has obtained data is determined (Op. 1). For example, the obtaining unit 14 receives an output value from the sensor to obtain data.

If the obtaining unit 14 has not obtained data (NO in Op. 1), the generation processing is terminated. On the other hand, if the obtaining unit 14 has obtained data (YES in Op. 1), the encryption section 123 encrypts payload data containing the obtained data (Op. 2). Then, the encrypted payload data is stored in the payload data portion 23 of the packet. Note that the payload data may contain, in addition to the obtained data, information, such as the time and period of obtaining data.

The generation section 121 stores the second header information in the second header portion 22 of the packet (Op. 3). For example, the generation section 121 sets, as the global transmission source address, the address of its own node. Furthermore, the generation section 121 sets, as the global transmission destination address, the address of the sink node SN.

Next, the calculation section 122 calculates a MAC value that is to be the second value for application data as a target using the application data MAC key (Op. 4). The application data contains the second header information stored in the second header portion 22 and the payload data stored in the payload data portion 23. The calculated MAC value is stored in the second value storage portion 25.

The generation section 121 stores the first header information in the first header portion 21 of the packet (Op. 5). For example, the generation section 121 sets, as the local transmission source address, the address of its own node. Furthermore, the generation section 121 sets the local transmission destination address with reference to the routing table. Information, such as the date and time of transmission and the number of transfers for the packet, and the like, may be stored in the first header portion.

For example, the generation section 121 identifies the local transmission destination address the evaluation value of which is the highest among a plurality of local transmission destination addresses associated with the global transmission destination address with reference to the routing table storage section 131. The generation section 121 sets the identified local transmission destination address in the first header portion 21.

Next, the calculation section 122 calculates a MAC value that is to be the first value for ad hoc data as a target using the ad hoc data MAC key (Op. 6). The ad hoc data contains the first header information stored in the first header portion 21, the second header information stored in the second header portion 22, and the payload data stored in the payload data portion 23. The calculated MAC value is stored in the first value storage portion 24.

The calculation section 122 obtains the ad hoc data MAC key corresponding to the previously determined local transmission destination address from the ad hoc data MAC key management table. Then, the calculation section 122 calculates the MAC value using the obtained ad hoc data MAC key.

The communication unit 11 transmits the generated packet to another node (Op. 7).

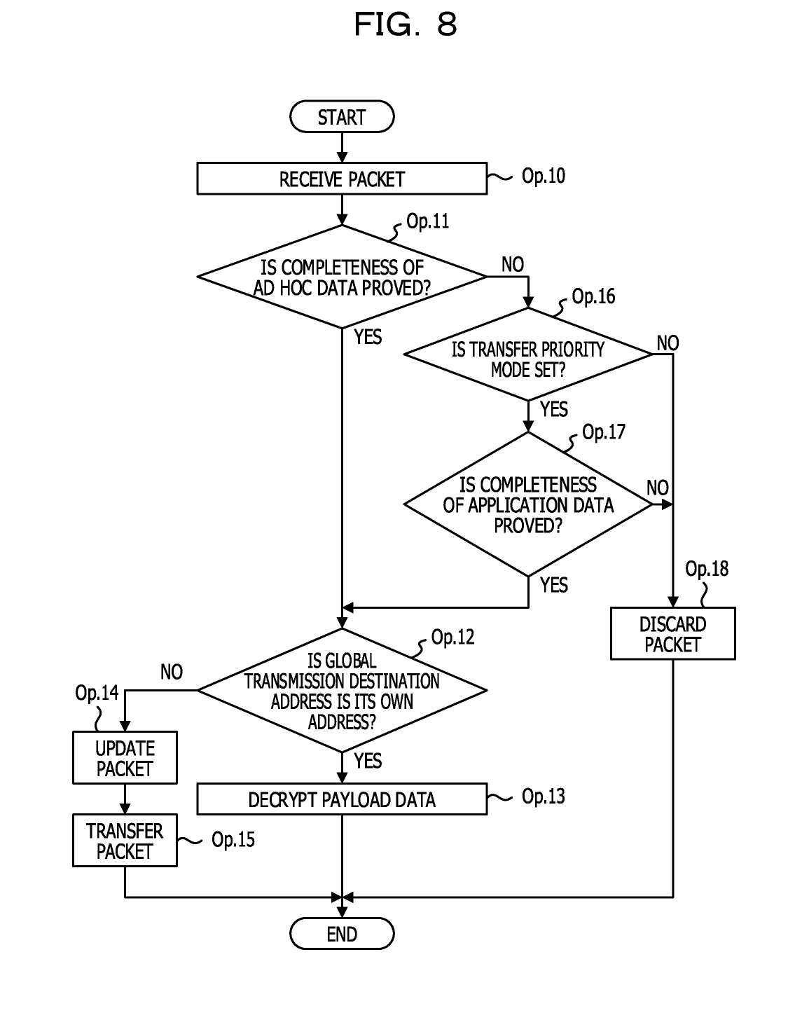

FIG. 8 is a flow chart of packet verification processing executed by the node that has received a packet.

The communication unit 11 receives a packet (Op. 10). Then, the verification section 124 verifies the completeness of ad hoc data using the first value stored in the first value storage portion 24 of the received packet (Op. 11).

The verification section 124 calculates a MAC value for the ad hoc data in the received packet using the verification MAC key. Then, the verification section 124 compares the MAC value stored in the first value storage portion 24 in the received packet and the calculated MAC value with one another. If the stored MAC value and the calculated MAC value match one another, it is proved that the ad hoc data in the received packet is the same as the ad hoc data at the time of transmission of the packet from another node. That is, the completeness of the ad hoc data is affirmed.

On the other hand, if the stored MAC value and the calculated MAC value do not match one another, it is denied that the ad hoc data in the received packet is the same as the ad hoc data at the time of transmission of the packet from another node. That is, the completeness of the ad hoc data is denied.

Also, in this example, the node that is to be the local transmission source selects the ad hoc data MAC key in accordance with the node that is to be the local transmission destination. Accordingly, in the node that is the local transmission destination, if the MAC value stored in the first value storage portion 24 in the packet and the calculated MAC value do not match one another, a probability that the ad hoc data MAC key that is different from the verification MAC key is used in the local transmission source node is detected. Furthermore, a probability that a node other than the node designated as the local transmission destination address has received the packet is detected.

If the completeness of the ad hoc data is verified (YES in Op. 11), the verification section 124 determines whether or not the global transmission destination address in the packet matches the address of its own node (Op. 12). If the global transmission destination address in the packet and the address of its own node match one another (YES in Op. 12), the decryption section 125 obtains the decryption key from the decryption key management table to decrypt the payload data stored in the payload data portion 23 in the received packet using the decryption key (Op. 13). Then, the node 10 terminates the verification processing.

Note that, if the result of the determination performed in Op. 12 is YES, for example, the packet transmitted from the server toward a specific node has reached to the specific node. Normally, when a packet containing data obtained by the obtaining unit 14 of each node N is transmitted to the server, the global transmission destination address is the address of a sink node that is capable of directly communicating with the server.

On the other hand, if the global transmission destination address in the packet does not match the address of its own node (NO in Op. 12), the generation section 121 and the calculation section 122 update a part of data in the packet (Op. 14). For example, the generation section 121 sets new first header information in the first header portion 21. Furthermore, the generation section 121 stores the first value calculated by the calculation section 122 in the first value storage portion 24.

Specifically, the generation section 121 sets, as the local transmission source address, the address of its own node and sets, as the local transmission destination address, the address of the node that is to be the next transmission destination. The calculation section 122 calculates the first value based on the new first header information and the application data that has been contained in the packet in advance. Then, the generation section 121 stores the calculated first value in the first value storage portion 24.

The communication unit 11 transfers the updated packet (Op. 15).

If the completeness of the ad hoc data is not verified in Op. 11 (NO in Op. 11), the verification section 124 determines whether or not the transfer priority mode is set (Op. 16). The transfer priority mode is a mode in which, when the completeness of the ad hoc data is denied, the completeness of the application data is further verified and in which priority is put in transfer of a packet.

If the transfer priority mode is set (YES in Op. 16), the verification section 124 verifies the completeness of the application data in the received packet (Op. 17).

The verification section 124 calculates a MAC value for the ad hoc data in the received packet using the application data MAC key. Note that, in this embodiment, in the node that is a transmission source of a packet, the application data MAC key that has been shared by all of the nodes in advance is used for the application data. Accordingly, the node that has received the packet uses the application data MAC key that has been shared by all of the nodes in advance for verifying the application data.

Then, the verification section 124 compares the MAC value stored in the 25 in the received packet and the calculated MAC value to one another. If the stored MAC value and the calculated MAC value match one another, it is proved that the application data in the received packet is the same as the application data at the time of transmission of the packet from another node. That is, the completeness of the application data is affirmed.

On the other hand, if the stored MAC value and the calculated MAC value do not match one another, it is denied that the application data in the received packet is the same as the application data at the time of transmission of the packet from another node. That is, the completeness of the application data is denied.

If the completeness of the application data is proved (YES in Op. 17), the verification section 124 causes the process to proceed to Op. 12. Note that the subsequent processing is as described above.

On the other hand, if the completeness of the application data is not proved (NO in Op. 17), the verification section 124 discards the received packet (Op. 18). Also, in Op. 16, if the transfer priority mode is not set (NO in Op. 16), the node 10 discards the packet (Op. 18). That is, if the security mode in which only the completeness of the ad hoc data is verified is set, the verification section 124 does not allow transfer of the packet the ad hoc data of which is not complete, thereby keeping security of the entire ad hoc network.

The above-described processing enables the node 10 to perform, when the node 10 receives a packet, verification of ad hoc data and verification of application data separately. That is, the node 10 is enabled to verify the completeness of ad hoc data, and then, to further verify the completeness of application data.

Thus, even when the completeness of ad hoc data is not proved, the node 10 can put priority on transfer of, for example, payload data in the packet to the global transmission destination address by further verifying the completeness of application data, and therefore, the packet is not excessively discarded.

For example, even when a part of additional information, such as the date and time of transmission, the number of transfers, and the like, contained in the first header information is rewritten during transmission of a packet for some reason, the node that has received the packet does not discard the packet. The same applies to the case where the local transmission source address and the local transmission destination address contained in the first header information are rewritten.

On the other hand, in transmitting a packet, each node 10 can select, as the first value, the ad hoc data MAC key corresponding to a node that is the local transmission destination. Thus, when the security priority mode is set for each node, the node that has received a packet can discard the packet transmitted from a node that has not shared the verification MAC key of the node that has received the packet in advance. For example, when an unauthorized node generates a packet and transmits it, the unauthorized node does not know the ad hoc data MAC key of the node that is to be the transmission destination. Therefore, the MAC value set in the packet and the MAC value calculated by the node that has received the packet do not match one another, and thus, each node can discard the packet transmitted from the unauthorized node.

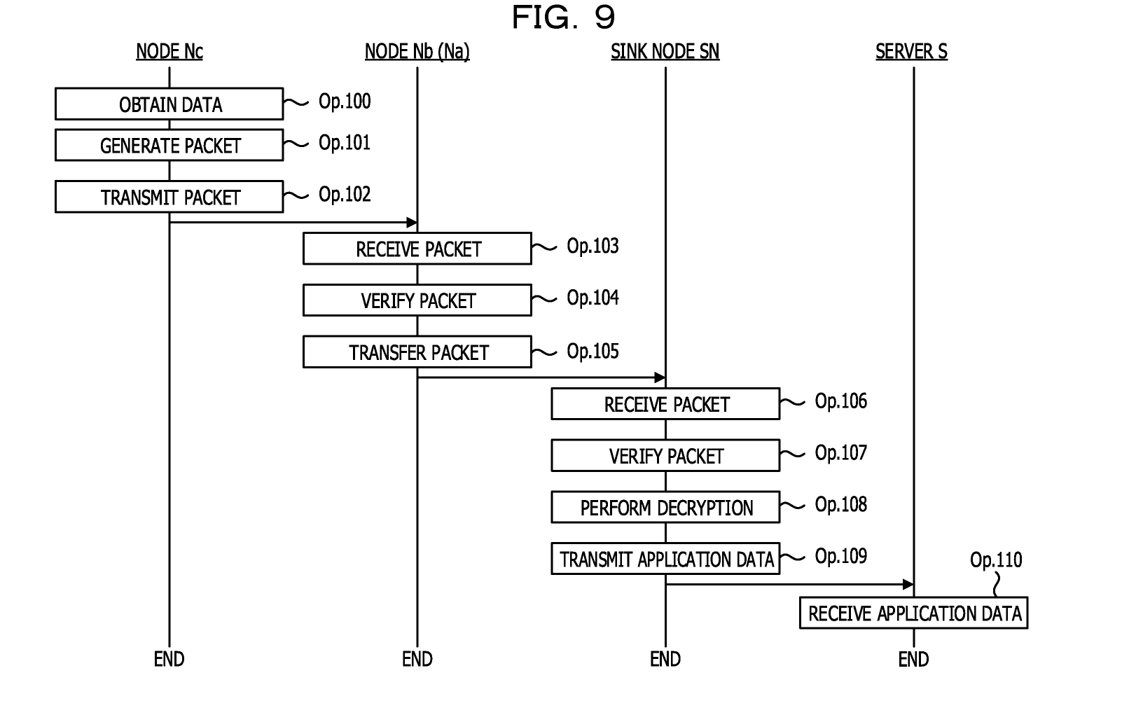

Next, a flow of transmission of a packet will be described with reference to a sequence diagram. FIG. 9 is a sequence diagram illustrating a flow of transmission of a packet within an ad hoc network. More specifically, FIG. 9 is a sequence diagram illustrating a case where the node Nc of FIG. 1 transmits payload data to the server S using the ad hoc network. In accordance with the route R1 of FIG. 1, a packet containing the payload data generated by the node Nc is transmitted to the sink node SN via the nodes Nb and Na. Thereafter, the sink node SN and the server S communicate with one another, so that the payload data is received by the server S.

First, the node Nc obtains data from the sensor or the like (Op. 100). Next, the node Nc generates payload data containing the obtained data and generates a packet containing the payload data (Op. 101). Note that the processing of generating the packet is as illustrated in FIG. 7.

Subsequently, the node Nc transmits the generated packet (Op. 102). A node, such as the node Nc, which generates a packet, is referred to as a first node. When each node functions as the first node, the each node includes the communication unit 11, the generation section 121, the calculation section 122, the encryption section 123, and the storage unit 13 illustrated in FIG. 4.

The node Nb that is communicable with the node Nc receives a packet transmitted from the node Nc (Op. 103). Then, the node Nb verifies the completeness of ad hoc data in the packet using the first value contained in the packet and verifies the completeness of application data using the second value, as appropriate (Op. 104).

If the completeness of application data in the received packet is proved, the node Nb generates a new packet containing the application data and transfers the packet (Op. 105). The packet transferred by the node Nb is received by the node Na that is communicable with the node Nb. Then, the node Na performs similar processing to processing performed by the node Nb.

On the other hand, if the completeness of the ad hoc data in the received packet is not proved and the completeness of the application data is not proved, the node Nb and the node Na discard the received packet.

A node, such as the nodes Nb and Na, which verifies a packet and further transfers the packet is referred to as the second node. When each node functions as the second node, the each node includes the communication unit 11, the generation section 121, the calculation section 122, the verification section 124, the storage unit 13, and the obtaining unit 14 illustrated in FIG. 4. Note that, although not illustrated in FIG. 9, when each node functions as a node corresponding to the final transmission destination address, the each node includes the communication unit 11, the verification section 124, the decryption section 125, and the storage unit 13 illustrated in FIG. 4.

Next, the sink node SN receives the packet (Op. 106). Note that, similar to the node 10, the sink node SN verifies the received packet (Op. 107). For example, the sink node executes the verification processing flow of the node 10 illustrated in FIG. 8. That is, the sink node SN includes at least the communication unit 11, the generation section 121, the verification section 124, the decryption section 125, and the storage unit 13 of the processing members of the node 10.

The sink node SN decrypts payload data in the received packet. Then, the sink node SN transmits application data containing the decrypted payload data to the server S (Op. 109). Note that the payload data may be transmitted as being encrypted to the server S. Then, the server S receives the application data (Op. 110).

The above-described processing enables the packet for which the completeness the application data is proved in the nodes Nb and Na that form a transmission route to reach the sink node that is the global transmission destination. Therefore, the payload data contained in the data obtained by the node Nc is received as a part of the application data by the server S via the sink node. That is, the server S can obtain the global transmission source address and the payload data contained in the application data.

According to another example, assuming that, while a packet is transmitted in an ad hoc network, an unauthorized node obtains the packet, security is further increased.

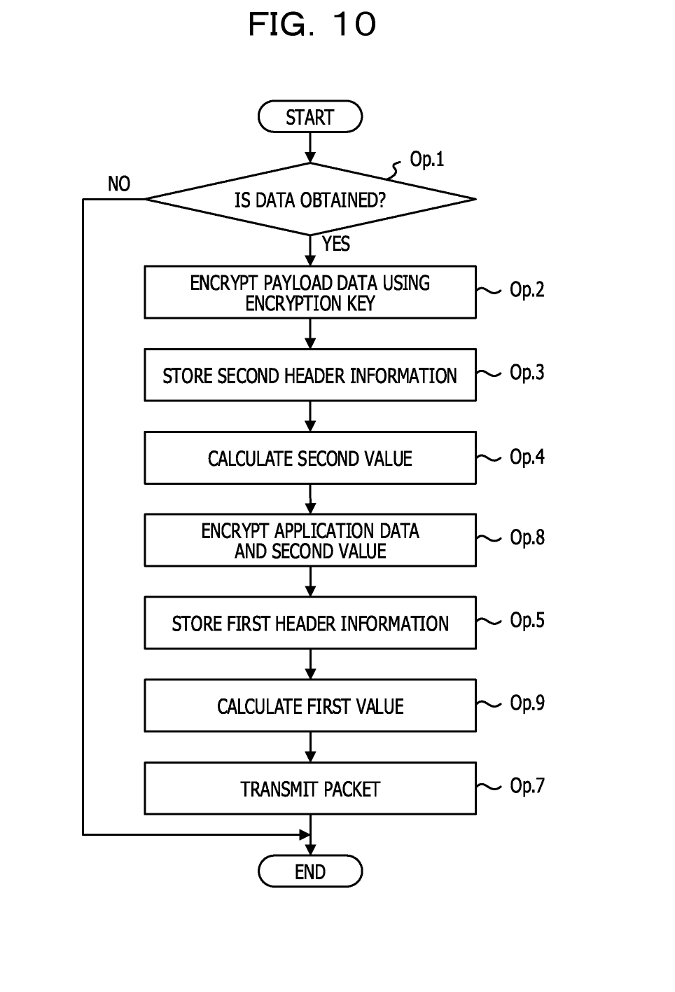

FIG. 10 is a flow chart of packet generation processing according to the another example. Note that similar processing to the processing of the above-described example is denoted by the same reference characters as those illustrated in FIG. 7 and the description thereof will be omitted. In addition, the function configuration of each node in the another example is similar to that in the above-described example.

In the another example, after the calculation section 122 calculates the second value, the encryption section 123 encrypts application data and the second value (Op. 8). Note that encryption is executed in accordance with an algorithm that has been set in advance.

For example, in this example, the encryption section 123 encrypts the application data and the second value using the ad hoc data MAC key for local transmission destination. Note that the ad hoc data MAC key is shared by authorized nodes in advance. In addition, the application data MAC key shared by all of the nodes or another encryption key may be used as the encryption key.

Then, after the generation section 121 generates the first header information, the calculation section 122 calculates the first value for the encrypted application data, the encrypted second value, and the first header information as targets (Op. 9). Thereafter, the communication unit 11 transmits a packet (Op. 7).

As described above, in the another example, in addition to payload data, application data is encrypted. Accordingly, the global transmission source address and the global transmission destination address are encrypted. Thus, according to the another example, the global transmission source address and the global transmission destination address are not obtained by a third party that operates an unauthorized node.

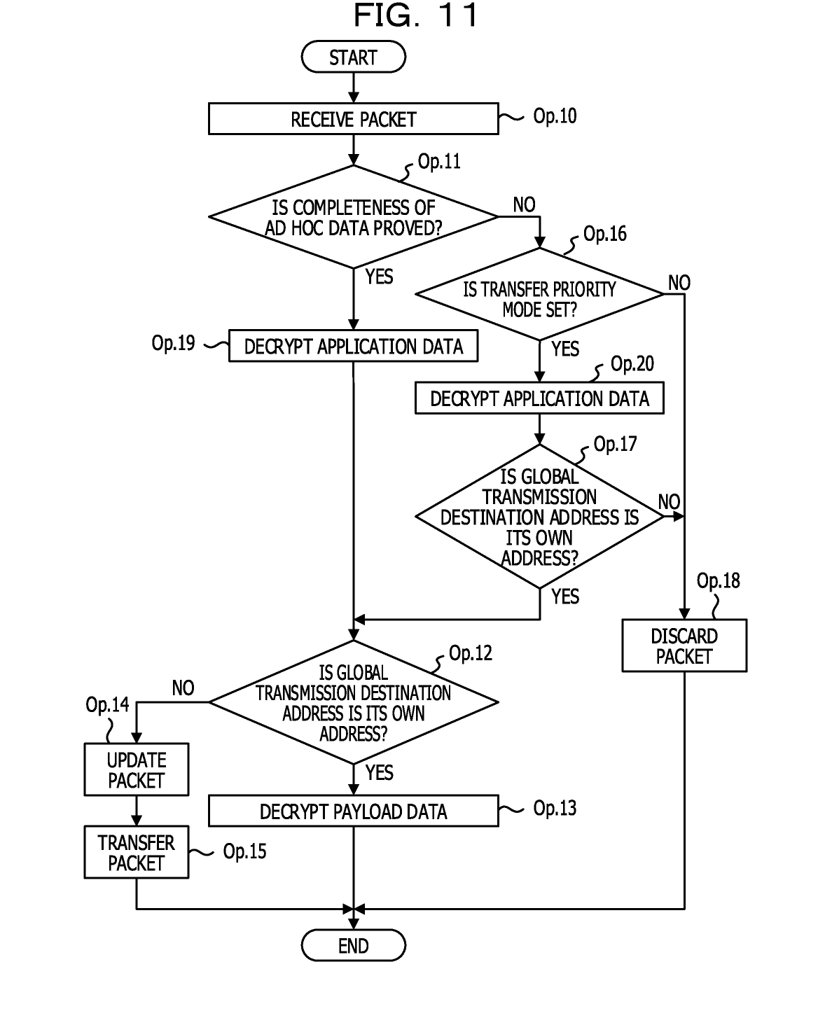

FIG. 11 is a flow chart of packet verification processing according to the another example. Note that similar processing to the processing of the above-described example is denoted by the same reference characters as those illustrated in FIG. 8 and the description thereof will be omitted.

First, in Op. 11, if the completeness of the ad hoc data is verified (YES in Op. 11), the decryption section 125 decrypts the encrypted application data and the encrypted second value (Op. 19). Note that decryption is executed in accordance with an algorithm that has been set in advance.

For example, in the another example, a node that transmits a packet encrypts application data and the second value using the ad hoc data MAC key for local transmission destination. Accordingly, a node that has received the packet performs decryption using the verification MAC key that has shared with the node that has transmitted the packet in advance. In addition, when decryption is not successful, the decryption section 125 discards the received packet.

Subsequently, the verification section 124 executes Op. 12 with reference to the decrypted application data. Note that the subsequent processing is similar to the processing of the above-described example.

On the other hand, if the completeness of the ad hoc data is not verified in Op. 11 (NO in Op. 11) and the transfer priority mode is set (YES in Op. 16), the decryption section 125 decrypts the encrypted application data and the encrypted second value (Op. 20). Note that decryption is executed in accordance with an algorithm that has been set in advance. If the encrypted application data and the encrypted second value are not decrypted, the received packet is discarded.

The verification section 124 executes Op. 17 with reference to the decrypted second value. Note that the subsequent processing is similar to the processing of the above-described example.

The above-described processing enables transmission of a packet with application data in the packet being encrypted. Therefore, even when a packet is stolen by an unauthorized node, application data is not obtained by the unauthorized node.

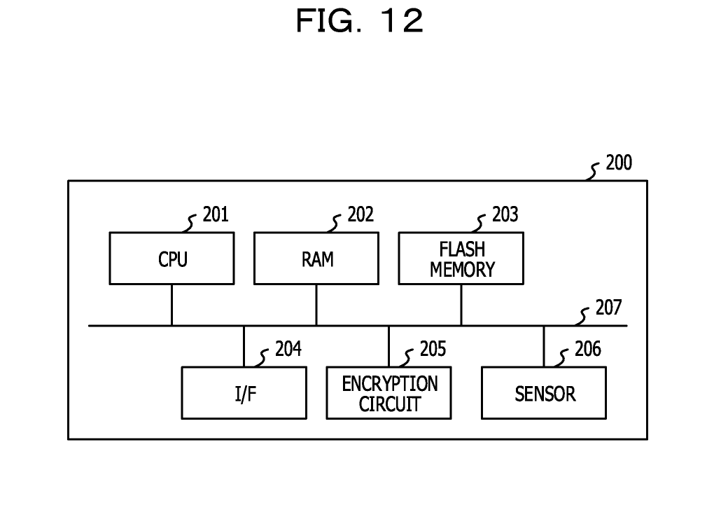

FIG. 12 is a diagram illustrating an example hardware configuration of the node N. A node 200 includes a central processing unit (CPU) 201, a random access memory (RAM) 202, a flash memory 203, an interface (I/F) 204, an encryption circuit 205, a sensor 206, and a bus 207. The members from CPU 201 to the sensor 206 are connected to one another via the bus 207.

The CPU 201 performs control over the entire node 200. The CPU 201 executes a program loaded in the RAM 202 to function as the communication unit 11, the control unit 12, the obtaining unit 14, or the like.

The RAM 202 is used as a work area of the CPU 201. The flash memory 203 stores programs, information of various types of keys, and a routing table. The flash memory 203 is an example of the storage unit 13. The programs include, for example, a program for use in executing each processing in a node illustrated in the flow charts described above. For example, a control program used for causing a node to execute packet generation processing and packet verification processing is stored in the flash memory 203.

The node 200 is caused to function as the various types of processing members illustrated in FIG. 4 by loading the programs stored in the flash memory 203 in the RAM 202 and causing the CPU 201 to execute the programs. In addition, the node 200 executes the processing illustrated in FIG. 7 and FIG. 8.

The I/F 204 transmits and receives a packet via multihop communication. The I/F 204 is an example of the communication unit 11.

The encryption circuit 205 is a circuit that encrypts data using an encryption key when performing encryption of the data. For example, when a packet is encrypted and is thus transmitted, the encryption circuit 205 functions. When encryption is executed using a software, a program corresponding to the encryption circuit 205 is stored in the flash memory 203, and thus, the encryption circuit 205 is not used.

The sensor 206 detects data that is unique to the sensor 206. For example, data corresponding to a target, such as temperature, humidity, water level, precipitation, airflow volume, sound volume, power consumption, time period, time, acceleration, and the like, which is to be measured. Note that, when the CPU 201 functions as the obtaining unit 14, data is obtained from the sensor 206.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A network system which includes a plurality of node devices and in which a packet including a first header portion, a second header potion, and a payload data portion is transferred, the network system comprising:
a first node device that is one of the plurality of nodes device and includes a first processor; and
a second node device that is one of the plurality of node devices and includes a second processor,
wherein
the first processor is configured to:
calculate a first value that is a first logical relationship for payload data set in the payload data portion and first header information including a transmission destination address set in the first header portion, and
transmit a packet including the payload data, the first header information, second header information including a final transmission destination address set in the second header portion, the first value, and a second value that is a second logical relationship to the payload data and the second header information to outside of the first node device,
the second processor is configured to perform, when a value that is to be the first logical relationship to information stored in the payload data portion in the packet received from outside of the second node device and information stored in the first header portion does not match the first value and a value that is the second logical relationship to information stored in the payload data portion in the received packet and information stored in the second header portion matches the second value, control that causes transmission of a packet based on the received packet to a third node device that is one of the plurality of node devices.

2. The network system according to claim 1, wherein the network system is an ad hoc network system.

3. A node device which is provided in a network and transmits a packet including a first header portion, a second header portion, a payload data portion, the node device comprising:
a memory; and
a processor coupled to the memory and configured to:
calculate a first value that is a first logical relationship for payload data set in the payload data portion and first header information including a transmission destination address set in the first header portion, and
transmit a packet including the payload data, the first header information, second header information including a final transmission destination address set in the second header portion, the first value and a second value that is a second logical relationship to the payload data and the second header information to outside of the node device.

4. The node device according to claim 3, wherein the processor is configured to:
obtain data from a sensor that outputs the data, and
calculate the second value for the payload data including the obtained data and the second information.

5. The node device according to claim 4, wherein the processor is configured to:
encrypt the payload data including the obtained data, and
calculate the first value for the encrypted payload data and the first header information.

6. The node device according to claim 5, wherein the processor is configured to encrypt the encrypted payload data and the second header information.

7. The node device according to claim 3, wherein
the memory is configured to store a routing table indicating a transfer route to a final transmission destination address for each final transmission destination address of the packet in the network, the final transmission destination address indicating other one or more node devices provided in the network system, and
the processor is configured to determine the transmission destination address based on the routing table.

8. The node device according to claim 3, wherein the processor is configured to calculate as the first value a message authentication code for the payload data and the first header information.

9. The node device according to claim 8, wherein
the memory is configured to store a key management table that manages a key used for calculating the message authentication code for each transmission destination address, and
the processor is configured to calculate the first value using the key corresponding to the transmission destination address in the key management table.

10. The node device according to claim 3, wherein the network system is an ad hoc network system.

11. A node device which performs verification using a value set in a packet by a device which has transmitted the packet, the node device comprising:
a memory; and
a processor coupled to the memory and configured to:
receive the packet including payload data set in a payload data portion, first header information including a transmission destination address set in a first header portion, second header information including a final transmission destination address set in a second header portion, a first value, and a second value,
verify whether or not a value that is to be a first logical relationship to the payload data and the first header information matches the first value,
verify, when the value that is to be the first logical relationship and the first value do not match one another, whether or not a value that is to be a second logical relationship to the payload data and the second header information and the second value match one another, and
perform, when the value that is to be the second logical relationship and the first value match one another, control that causes transmission of another packet based on the received packet.

12. The node device according to claim 11, wherein the processor is configured to discard, when the value that is to be the second logical relationship and the second value do not match one another, the received packet.

13. The node device according to claim 11, wherein the processor is configured to calculate, as the value that is to be the first logical relationship, a message authentication code for the payload data and the first header information based on an algorithm that has been set in advance.

14. The node device according to claim 11, wherein the processor is configured to transmit the another packet including the payload data and the second header information to another node device in accordance with the control.

15. The node device according to claim 11, wherein the network system is an ad hoc network system.

16. A method of controlling a network system which includes a plurality of node devices and in which a packet including a first header portion, a second header potion, and a payload data portion is transferred, the method comprising:
calculating, by a first node device among the plurality of nodes device, a first value that is a first logical relationship for payload data set in the payload data portion and first header information including a transmission destination address set in the first header portion,
transmit, by the first node device, a packet including the payload data, the first header information, second header information including a final transmission destination address set in the second header portion, the first value, and a second value that is a second logical relationship to the payload data and the second header information to outside of the first node device,
performing, by a second node device among the plurality of node devices, when a value that is to be the first logical relationship to information stored in the payload data portion in the packet received from outside of the second node device and information stored in the first header portion does not match the first value and a value that is the second logical relationship to information stored in the payload data portion in the received packet and information stored in the second header portion matches the second value, control that causes transmission of a packet based on the received packet to a third node device among the plurality of node devices.

17. The method according to claim 16, wherein the network system is an ad hoc network system.
